(19) United States
(12) Patent Application Publication
(10) Pub. No.: US 2007/0002235 A1
(43) Pub. Date: Jan. 4, 2007

(54) Electro-optical device, method for manufacturing the same, and electronic apparatus

(75) Inventors: Takaaki Tanaka, Matsumoto-shi (JP); Hiroyuki Kojima, Suwa-shi (JP); Shinsuke Seki, Chino-shi (JP)

Correspondence Address: ADVANTEDGE LAW GROUP, LLC, 1928 E. COBBLESTONE RD., SUITE 100, SPRINGVILLE, UT, 84663, US

(73) Assignee: Seiko Epson Corporation, Shinjuku-ku (JP)

(21) Appl. No.: 11/473,477

(22) Filed: Jun. 23, 2006

(30) Foreign Application Priority Data
Jul. 4, 2005 (JP) 2005-195298

(51) Int. Cl. G02F 1/1337

(52) U.S. Cl. 349/123

(57) ABSTRACT

An electro-optic device includes a pair of first and second substrates, an electro-optic material sandwiched between the pair of first and second substrates, and an alignment film for controlling the alignment state of the electro-optic material, the alignment film being composed of an inorganic material to which an organic compound is fixed by reaction and being formed on a surface of at least one of the first and second substrates on the side facing the electro-optic material.

### BACKGROUND

1. Technical Field

The present invention relates to an electro-optic device, e.g., a liquid crystal display, a method for manufacturing the same, and an electronic apparatus.

2. Related Art

In such an electro-optic device, the alignment of an electro-optic material sandwiched between a pair of substrates which are bonded together with, for example, a sealing material, is controlled by, for example, an inorganic alignment film formed on a surface of at least one of the pair of substrates, the surface facing the electro-optic material. In manufacturing an electro-optic device, an inorganic alignment film is formed by, for example, oblique evaporation. In the inorganic alignment film formed on the surface of a substrate by oblique evaporation, electrically unstable defects may occur on the surface or inside the film due to dangling bonds, thereby failing to obtain satisfactory film quality. The electrically unstable defects in the inorganic alignment film react with, for example, water to form silanol groups. After the assembly of the electro-optic device, for example, liquid crystal molecules in contact with the inorganic alignment film may photochemically react with the silanol groups. The photochemical reaction causes leak light or the like due to bonding between the liquid crystal molecules and the silanol groups, thereby degrading the quality of a display image in the electro-optic device.

For example, Japanese Unexamined Patent Application Publication No. 2-39024 discloses a technique of laminating an organic film on an inorganic alignment film formed by oblique evaporation, in order to prevent the occurrence of alignment defects in the inorganic alignment film at high temperature and high humidity. Japanese Unexamined Patent Application Publication No. 3-259116 discloses a technique of depositing an organic vertical alignment film on an inorganic alignment film, for controlling the pretilt angle of a liquid crystal. Japanese Unexamined Patent Application Publication No. 2000-47211 discloses a technique of wetting the surface of an inorganic alignment film with a higher alcohol, for modifying the interaction between a ferroelectric liquid crystal and the inorganic alignment film.

However, according to the techniques disclosed in Japanese Unexamined Patent Application Publication Nos. 2-39024 and 3-259116, an organic film is laminated on an inorganic alignment film to form a two-layer film without causing a chemical reaction, and thus silanol groups may be present. Therefore, a photochemical reaction between liquid crystal molecules and silanol groups may not be sufficiently prevented. The technique disclosed in Japanese Unexamined Patent Application Publication No. 2000-47211 improves the affinity between a ferroelectric liquid crystal and an inorganic alignment film, but a photochemical reaction between liquid crystal molecules and silanol groups may not be prevented.

### SUMMARY

An advantage of the invention is that it provides an electro-optic device capable of suppressing a photochemical reaction between an electro-optic material and an inorganic alignment film, a method for manufacturing the same, and various electronic apparatuses each including the electro-optic device.

According to an aspect of the invention, an electro-optic device includes a pair of first and second substrates, an electro-optic material sandwiched between the pair of first and second substrates, and an alignment film for controlling the alignment state of the electro-optic material, the alignment film being composed of an inorganic material to which an organic compound is fixed by reaction and being formed on a surface of at least one of the first and second substrates using on the side facing the electro-optic material.

It is preferable that the pair of first and second substrates are bonded together with a sealing material in a seal region along the periphery of a pixel array region, and the electro-optic material, e.g., a liquid crystal, is sandwiched between the pair of first and second substrates. Under a condition in which the electro-optic devices is not driven, the electro-optic material takes a predetermined alignment state between the pair of first and second substrates due to the surface shape effect of the alignment film composed of the inorganic material, i.e., the inorganic alignment film. When the electro-optic device is driven, a voltage is applied to each of pixels arrayed in the pixel array region according to an image signal to change the alignment state of the electro-optic material, thereby modulating light emitted from, for example, a light source. As a result, the light modulated by the electro-optic material is emitted as display light to display an image.

It is preferable that the inorganic alignment film is typically deposited on a substrate by, for example, oblique evaporation of silica (SiO₂) or the like. In this case, a laminated structure including wiring and driver elements for driving pixel electrodes is previously formed as an underlying base for the inorganic alignment film on the surface of the first substrate, and the pixel electrodes are formed in a predetermined island or stripe pattern for the respective pixels in the uppermost layer of the laminated structure. Alternatively, a laminated structure is formed on the surface of the second substrate, the laminated structure including a light shielding film formed for defining aperture regions of the respective pixels, and a counter electrode disposed in the uppermost layer so as to oppose a plurality of pixel electrodes.

The inorganic alignment film typically contains silanol groups (—Si—OH) at its surface. If no treatment is performed, silanol groups have high reactivity and thus react with the electro-optic material, for example, liquid crystal molecules, sandwiched between the pair of first and second substrates. In particular, silanol groups react by the action of light applied during use as a device, i.e., photochemically react.

In the electro-optic device, it is preferable that the organic compound is fixed, by reaction, to the surface of the inorganic alignment film on the side facing the electro-optic material. The term “fixed by reaction” means that the organic compound is bonded to a functional group of the alignment film by a chemical reaction. For example, the silanol groups with high reaction activity which are possessed by the surface of the inorganic alignment film are bonded to an organic compound, e.g., isopropanol, due to dehydration reaction. Consequently, the reaction activity of the inorganic alignment film is decreased, thereby suppressing or eliminating the photochemical reaction between the inorganic alignment film and liquid crystal molecules. In other words, it may be possible to prevent the photoreaction between the inorganic alignment film and the electro-optic material through the silanol groups serving as reaction active sites. Namely, the silanol groups serving as reaction active sites are chemically modified to modify the surface of the inorganic alignment film.

As described above, it may be possible to suppress the photochemical reaction between the inorganic alignment film and the electro-optic material, thereby decreasing or eliminating display defects due to the photochemical reaction between the inorganic alignment film and the electro-optic material.

In the electro-optic device, the organic compound preferably has a predetermined wavelength absorption band.

In this case, since the organic compound has the predetermined wavelength absorption band, absorption of light used for, for example, a projector, may be prevented using the organic compound having substantially no or no short-wavelength absorption band, for example, about 300 to 400 nm or less. Therefore, it may be possible to more securely prevent the photochemical reaction between the liquid crystal molecules and silanol groups near the surface of the alignment film.

In the electro-optic device, the organic compound is preferably an alcohol.

In this case, the organic compound is an alcohol and thus easily causes a dehydration or condensation reaction with a hydroxyl group or silanol group. Therefore, the organic compound may be securely fixed to the inorganic alignment film by reaction.

In the electro-optic device, the organic compound is preferably a silane compound.

In this case, the organic compound is a silane compound and easily reacts with a hydroxyl group or silanol group. Therefore, the organic compound may be securely fixed to the inorganic alignment film by reaction.

In the electro-optic device, the organic compound is preferably a fatty acid.

In this case, the organic compound is a fatty acid and easily causes a dehydration or condensation reaction with, for example, a hydroxyl group or silanol group. Therefore, the organic compound may be securely fixed to the inorganic alignment film by reaction.

According to another aspect of the invention, an electronic apparatus includes the above-described electro-optic device (including various forms).

The electronic apparatus includes the above-described electro-optic device, and thus it may be possible to realize various electronic apparatuses capable of high-quality image display, such as a projection-type display, a television, a cellular phone, an electronic notebook, a word processor, a view finder-type or monitor direct-view-type tape recorder, a work station, a picture phone, a POS terminal, a touch panel, and the like.

According to still another aspect of the invention, a method for manufacturing an electro-optic device including a pair of first and second substrates, and an electro-optic material sandwiched between the pair of first and second substrates includes forming an alignment film on at least one of the first and second substrates using an inorganic material, for controlling the alignment state of the electro-optic material; fixing an organic compound to a surface of the alignment film by reaction on the side facing the electro-optic material; and bonding the first and second substrates together.

The method is capable of manufacturing the above-described electro-optic device. In particular, the electro-optic device manufactured by the method has high light stability because the organic compound is fixed to the surface of the inorganic alignment film by reaction on the side facing the electro-optic material.

The method for manufacturing the electro-optic device preferably further includes, before the reaction fixing, removing impurities of the surface, generating hydroxyl groups on the surface after the removal of impurities, and adsorbing the organic compound on the surface after the hydroxyl groups are generated. The organic compound preferably has a predetermined wavelength absorption band.

In this case, the method further includes removing impurities, generating hydroxyl groups, and adsorbing the organic compound. These steps may be performed as pre-steps before the reaction fixing.

First, in the impurity removing step, impurities such as moisture in air, organic substances, and the like, which are adsorbed on or bonded by chemical reaction to the surface of the inorganic alignment film formed in the alignment forming step on the side facing the electro-optic material, are removed by, for example, O₂ plasma.

Next, in the hydroxyl group generating step, the surface of the inorganic alignment film on the side contacting the electro-optic material is immersed in, for example, pure water to substantially or completely uniformly produce hydroxyl groups, typically silanol groups, on the surface.

Next, in the adsorption step, the organic compound, such as isopropanol is adsorbed on the surface of the inorganic alignment film.

Since the impurity removing step, the hydroxyl group generating step, and the adsorption step are performed as pre-steps before the reaction fixing step, the organic compound may be substantially or completely uniformly fixed, by reaction, to the surface of the inorganic alignment film on the side facing the electro-optic material. Therefore, it may be possible to manufacture an electro-optic device having higher light stability.

Since the organic compound has the predetermined absorption wavelength band, the photochemical reaction between the electro-optic material, for example, liquid crystal molecules, and silanol groups near the surface of the alignment film may be more securely suppressed by the organic compound having substantially no or no short-wavelength absorption band, e.g., about 300 to 400 nm or less.

The operation and other advantages of the invention will be made clear from the description of embodiments below.

### BRIEF DESCRIPTION OF THE DRAWINGS

The invention will be described with reference to the accompanying drawings, wherein like numbers reference like elements.

FIG. 1 is a plan view showing the whole configuration of a liquid crystal device according to a first embodiment of the invention.

FIG. 2 is a sectional view taken along line II-II in FIG. 1.

FIG. 3 is a schematic view illustrating the alignment of a liquid crystal by an alignment film.

FIG. 4 an equivalent circuit diagram showing elements, wiring, and the like of a plurality of pixels.

FIG. 5 is a schematic view showing a surface of an alignment film according to the first embodiment.

FIG. 6 is a schematic view of a comparative example corresponding to FIG. 5.

FIG. 7 is a flow chart illustrating steps of a process for manufacturing an electro-optic device according to the first embodiment.

FIG. 8 is a flow chart illustrating in detail steps for modifying a surface.

FIGS. 9A, 9B, and 9C are schematic views showing in order the chemical structures of a surface of an alignment film in respective steps for modifying the surface.

FIG. 10 is a plan view showing the configuration of a projector as an example of an electronic apparatus including an electro-optic device.

FIG. 11 is a perspective view showing the configuration of a personal computer as an example of an electronic apparatus including an electro-optic device.

FIG. 12 is a perspective view showing the configuration of a cellular phone as an example of an electronic apparatus including an electro-optic device.

### DESCRIPTION OF EXEMPLARY EMBODIMENTS

An embodiment of the present invention will be described with reference to the drawings. In the embodiment descried below, a TFT active matrix-driven liquid crystal device with a built-in driving circuit is described as an example of an electro-optic device.

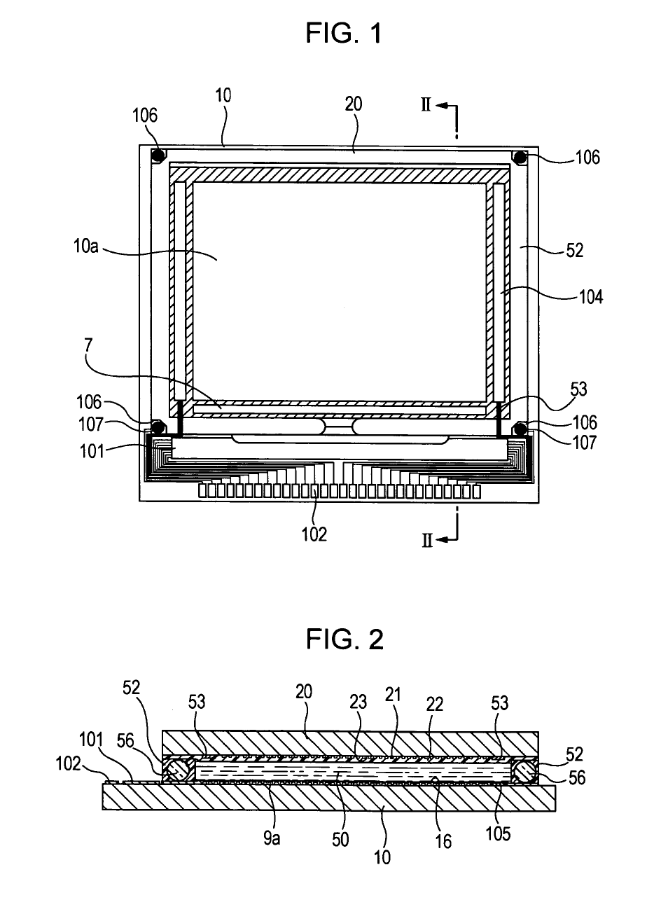

First, the whole configuration of an electro-optic device according to an embodiment of the invention will be described below with reference to FIGS. 1 and 2. FIG. 1 is a plan view showing a TFT array substrate together with the respective components formed thereon as viewed from a counter substrate. FIG. 2 is a sectional view taken along line II-II in FIG. 1. In each of the drawings referred to below, layers and members are shown on different reduction scales in order to make the size of each of the layers and members recognizable on the drawing.

In FIGS. 1 and 2, the electro-optic device according to the embodiment includes a TFT array substrate 10 as an example of a first substrate and a counter substrate 20 as an example of a second substrate, both substrates being opposed to each other. In addition, a liquid crystal layer 50 is sealed between the TFT array substrate 10 and the counter substrate 20, and the TFT array substrate 10 and the counter substrate 20 are bonded together with a sealing material 52 provided in a seal region disposed in the periphery of an image display region 10a.

The sealing material 52 for bonding both substrates together is composed of, for example, an ultraviolet curable resin, a heat curable resin, a ultraviolet-heat curable resin, or the like and is cured by ultraviolet irradiation or heating after being applied on the TFT array substrate 10 in the manufacturing process. The sealing material 52 contains a gap material 56, such as glass fibers or glass beads, dispersed therein for obtaining a predetermined gap between the TFT array substrate 10 and the counter substrate 20. FIG. 2 shows the configuration in which substantially spherical glass beads are mixed as the gap material 56 in the sealing material 52. The gap material 56 may be disposed in the image display region 10a or the peripheral region in the periphery of the image display region 10a in addition to or instead of mixing in the sealing material 52.

In FIG. 1, in order to define a frame region of the image display region 10a, a light-shielding frame film 53 is provided on the counter substrate 20 so as to be disposed in parallel with the inside of the seal region in which the sealing material 52 is disposed. However, the light-shielding frame film 53 may be partially or entirely provided as a built-in light-shielding film on the TFT array substrate 10.

In the peripheral region, data line driving circuits 101 and external circuit connection terminals 102 are provided along one of the sides of the TFT array substrate 10 and outside the seal region in which the sealing material 52 is disposed. Furthermore, sampling circuits 7 are provided inside the seal region and along that side so as to be covered with the light-shielding frame film 53. Furthermore, scanning line driving circuits 104 are provided inside the seal region and along the two sides adjacent to that side so as to be covered with the light-shielding frame film 53.

In addition, vertical conducting terminals 106 are disposed in regions on the TFT array substrate 10, which correspond to the four corners of the counter substrate 20, in order to connect both substrates through vertical conducting materials 107. Therefore, electric conduction is achieved between the TFT array substrate 10 and the counter substrate 20.

In FIG. 2, a laminated structure including pixel switching TFTs (Thin Film Transistors) serving as driver elements, scanning lines, data lines, and the like is formed on the TFT array substrate 10. Although the details of the laminated structure are not shown in FIG. 2, the uppermost layer of the laminated structure includes pixel electrodes 9a composed of a transparent material such as ITO (Indium Tin Oxide) and formed in a predetermined island pattern for respective pixels. In addition, an alignment film 16 composed of an inorganic material, e.g., silica (SiO₂), is provided on the pixel electrodes 9a.

On the other hand, a light-shielding film 23 is formed on the surface of the counter substrate 20 on the side facing the TFT array substrate 10. The light-shielding film 23 is formed in a planar lattice pattern on the facing surface of the counter substrate 20. In the counter substrate 20, non-aperture regions are defined by the light-shielding film 23, and aperture regions are partitioned by the light-shielding film 23. The light-shielding film 23 may be formed in a stripe pattern so that non-aperture regions are defined by the light-shielding film 23 and the components such as the data lines and the like provided on the TFT array substrate 10.

Furthermore, a counter electrode 21 composed of a transparent material such as ITO or the like is formed on the light-shielding film 23 so as to oppose the plurality of pixel electrodes 9a. In addition, a color filter (not shown in FIG. 2) may be formed in a region including portions of the aperture regions and non-aperture regions of the light-shielding film 23, for performing a color display in the image display region 10a.

Furthermore, an alignment film 22 composed of an inorganic material, e.g., silica (SiO₂), is formed on the laminated structure formed on the facing surface of the counter substrate 20 and including the various components formed therein. The counter electrode 21 is disposed in the uppermost layer of the laminated structure formed on the counter substrate 20, and the alignment film 22 is formed on the counter electrode 21.

An alignment film may be formed on the facing surface of one of the TFT array substrate 10 and the counter substrate 20. In addition, one of the alignment film 16 on the TFT array substrate 10 and the alignment film 22 on the counter substrate 20 may be an organic alignment film prepared by rubbing an organic film composed of an organic material such as polyimide or the like. However, an inorganic alignment film has higher light stability than that of an organic alignment film, and thus an inorganic alignment is preferably used for increasing the life of an electro-optic device.

The liquid crystal layer 50 includes one nematic liquid crystal or a mixture of a plurality of nematic liquid crystals and assumes a predetermined alignment state between the pair of alignment films 16 and 22 with no electric field applied from the pixel electrodes 9a.

As described in detail below, an organic compound is fixed, by reaction, to the surface of each of the alignment films 16 and 22 on the side facing the liquid crystal layer 50.

In addition to the data line driving circuits 101, the scanning line driving circuits 104, and the like, components which may be formed on the TFT array substrate 10 shown in FIGS. 1 and 2 include a sampling circuit for sampling image signals from image signal lines and supplying the image signals to the data lines, a pre-charge circuit for supplying a pre-charge signal at a predetermined voltage level to the plurality of data lines prior to the image signals, an inspection circuit for inspecting quality, defects, and the like of the electro-optic device during the manufacture and shipment, etc.

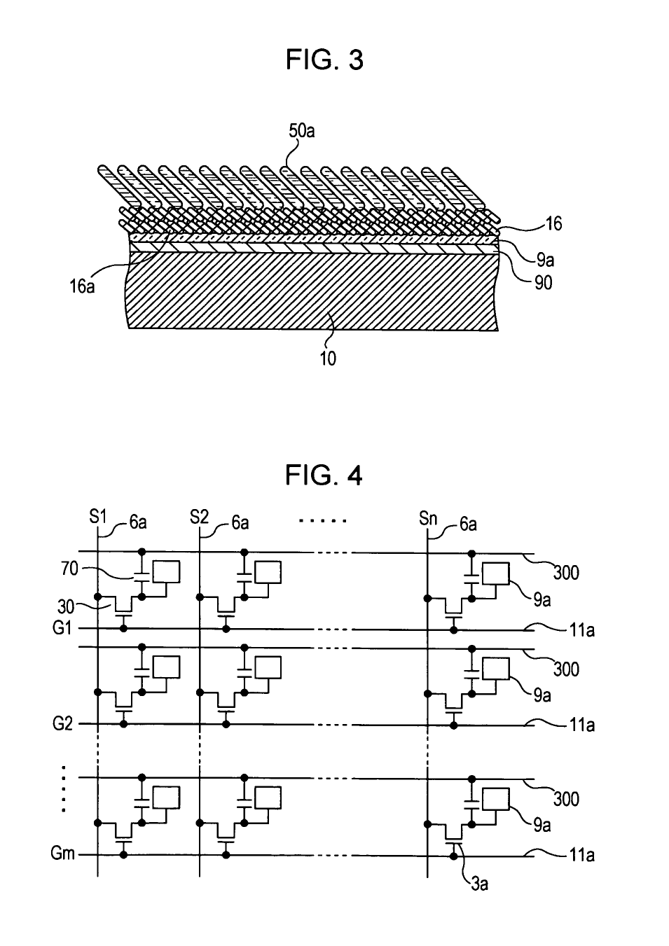

FIG. 3 schematically shows the configuration of a section corresponding to FIG. 2, particularly the alignment of a liquid crystal by the alignment film 16 formed on the TFT array substrate 10.

In FIG. 3, the laminated structure 90 including various components such as the TFTs and the like is formed on the surface of the TFT array substrate 10 on the side facing the liquid crystal layer 50, and the pixel electrodes 9a are formed for the respective pixels in the uppermost layer of the laminated structure 90. In addition, the alignment film 16 is formed on the pixel electrodes 9a by depositing an inorganic material in such a manner that columnar structures 16a of the inorganic material are arrayed at a predetermined angle with respect to the surface of the TFT array substrate 10. The thus formed alignment film 16 is capable of controlling the alignment state of liquid crystal molecules 50a by the surface shape effect. The alignment of the liquid crystal by the alignment film 16 descried above with reference to FIG. 3 applies to the alignment film 22 formed on the counter substrate 20.

Next, the circuit configuration and operation of the electro-optic device having the above-mentioned configuration will be described with reference to FIG. 4. FIG. 4 is an equivalent circuit diagram showing elements, wiring, and the like in a plurality of pixels which constitute an image display region of the electro-optic device and which are formed in a matrix pattern.

In FIG. 4, the plurality of pixels which are formed in a matrix pattern and which constitute the image display region 10a of the electro-optic device according to the embodiment of the invention includes the respective pixel electrodes 9a and the TFTs 30 formed for switching control of the respective pixel electrodes 9a, and data lines 6a to which image signals are supplied are electrically connected to the sources of the TFTs 30. Image signals S1, S2, Sn written on the respective data lines 6a may be line-sequentially supplied or may be supplied for each group including the adjacent data lines 6a.

In addition, gate electrodes 3a are electrically connected to the gates of the TFTs 30 so that scanning signals G1, G2, . . . , Gm are line-sequentially applied in a pulse form to the scanning lines 11a and the gate electrodes 3a with predetermining timing. The pixel electrodes 9a are electrically connected to the drains of the respective TFTs 30 so that the switches of the TFTs 30 serving as switching elements are closed only for a predetermined time to write the image signals S1, S2, . . . , Sn supplied from the respective data lines 6a with predetermined timing.

The image signals S1, S2, . . . , Sn at a predetermined level written in a liquid crystal, which is an example of the electro-optic material, through the pixel electrodes 9a are held for a predetermined time between the pixel electrodes 9a and the counter electrode 21 formed on the counter substrate 20. The alignment and order of molecular assemblies of the liquid crystal are changed according to the voltage level applied, thereby modulating light and permitting a gradation display. In a normally white mode, the transmittance of incident light decreases according to the voltage applied by pixel units, while in a normally black mode, the transmittance of incident light increases according to the voltage applied by pixel units. Therefore, as a whole, light with contrast corresponding to image signals is emitted from the electro-optic device.

In order to prevent the leakage of the held image signals, storage capacitors 70 are added in parallel with the liquid crystal capacities formed between the pixel electrodes 9a and the counter electrode 21. The storage capacitors 70 are provided in parallel with the scanning lines 11a and include fixed potential-side capacitor electrodes and capacitor electrodes 300 fixed to a predetermined potential.

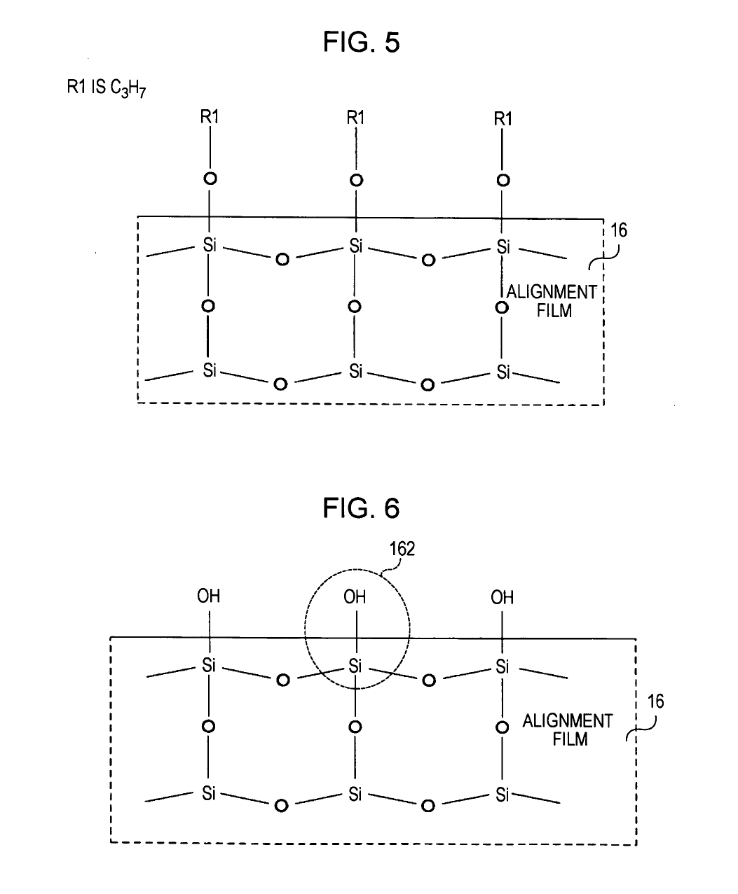

Next, the chemical structure of the surface of an alignment film according to the embodiment of the invention will be described with reference to FIGS. 5 and 6. FIG. 5 is a schematic view showing the chemical structure of the surface of an alignment film according to the embodiment of the invention, and FIG. 6 is a schematic view of a comparative example corresponding to FIG. 5.

As shown in FIG. 5, in the embodiment, isopropyl groups R1 (—C₃H₇) are bonded to the surface of the alignment film 16 on the side facing the liquid crystal layer 50.

As shown in FIG. 6, in the comparative example, the alignment film 16 composed of an inorganic material such as silica (SiO₂) easily reacts with external moisture to typically form silanol groups (—Si—OH) on the surface. If no treatment is made, silanol groups have high reactivity and thus react with the liquid crystal molecules of the liquid crystal layer 50 sandwiched between the TFT array substrate 10 and the counter substrate 20. In particular, silanol groups react by the action of light applied during use as an apparatus, for example, a projector or the like. In other words, photochemical reaction takes place.

However, in the embodiment of the invention, as descried above, isopropyl groups R1 (—C₃H₇) are bonded to the surface of the alignment film 16 on the side facing the liquid crystal layer 50. Namely, for example, isopropanol, is fixed to the alignment film 16 by reaction through silanol groups (—Si—OH) serving as reaction active sites present on the surface of the alignment film 16. Therefore, the reaction activity of the surface of the alignment film 16 is decreased, thereby suppressing the photochemical reaction between the alignment film 16 and the liquid crystal molecules of the liquid crystal layer 50. Namely, it may be possible to prevent photoreaction between the alignment film 16 and the liquid crystal layer 50 through silanol groups serving as reaction active sites. In other words, the surface of the alignment film 16 may be modified by chemically modifying silanol groups serving as reaction active sites.

In particular, in the embodiment of the invention, isopropanol, i.e., an alcohol, is fixed to the alignment film 16 by reaction. Since alcohols easily produce dehydration or condensation reaction with silanol groups 162, alcohols may be securely fixed to the alignment film 16 by reaction. As the organic compound fixed by reaction to the alignment film 16, a silane compound, a fatty acid, or the like is preferably used because it easily reacts with a silanol group or a hydroxyl group. Also, when an organic compound having substantially no or no short-wavelength absorption band, for example, about 300 to 400 nm or less, is fixed by reaction to the alignment film 16, absorption of light used for, for example, a protector, may be prevented, thereby more securely suppressing the photochemical reaction between the liquid crystal molecules and the silanol groups 162 near the surface of the alignment film 16.

Similarly, an organic compound such as isopropanol is fixed by reaction to the surface of the alignment film 22 on the side facing the liquid crystal layer 50.

Even when the organic compound is fixed by reaction to one of the alignment films 16 and 22, the effect of suppressing the photochemical reaction may be properly obtained.

As described above, the photochemical reaction between the alignment films 16 and 22 and the liquid crystal layer 50 may be suppressed, thereby decreasing or eliminating display defects due to the photochemical reaction between the alignment films 16 and 22 and the liquid crystal layer 50.

(Method for Manufacturing Electro-Optic Device)

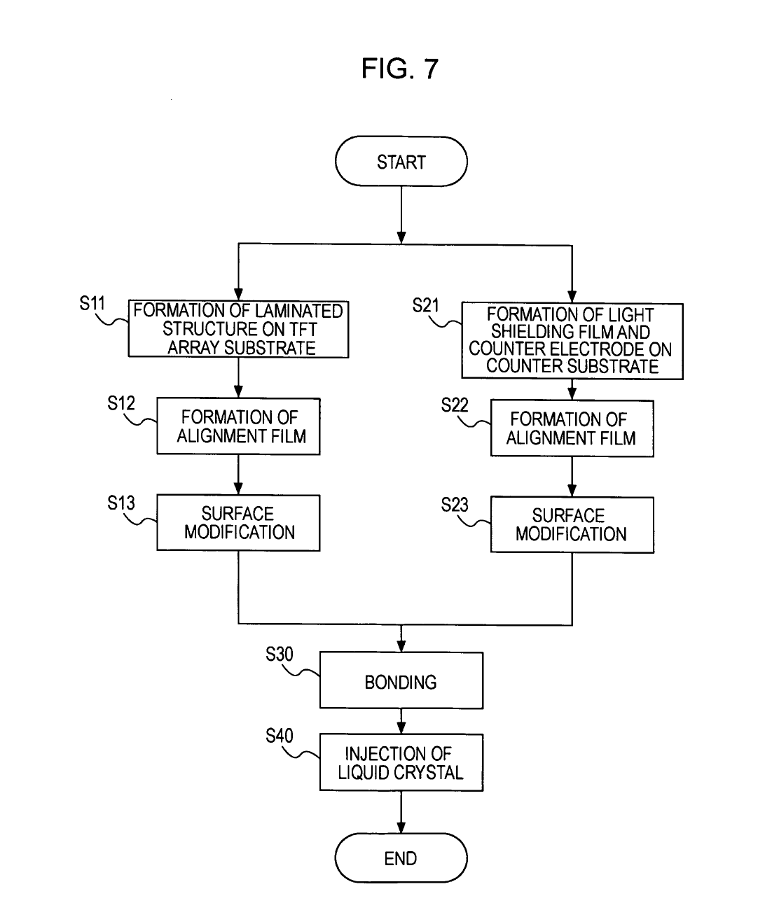

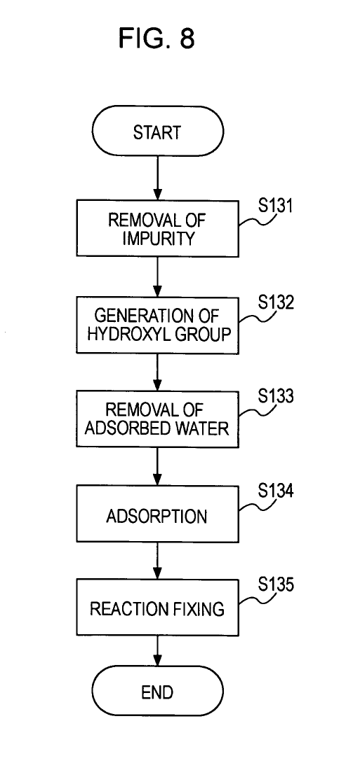

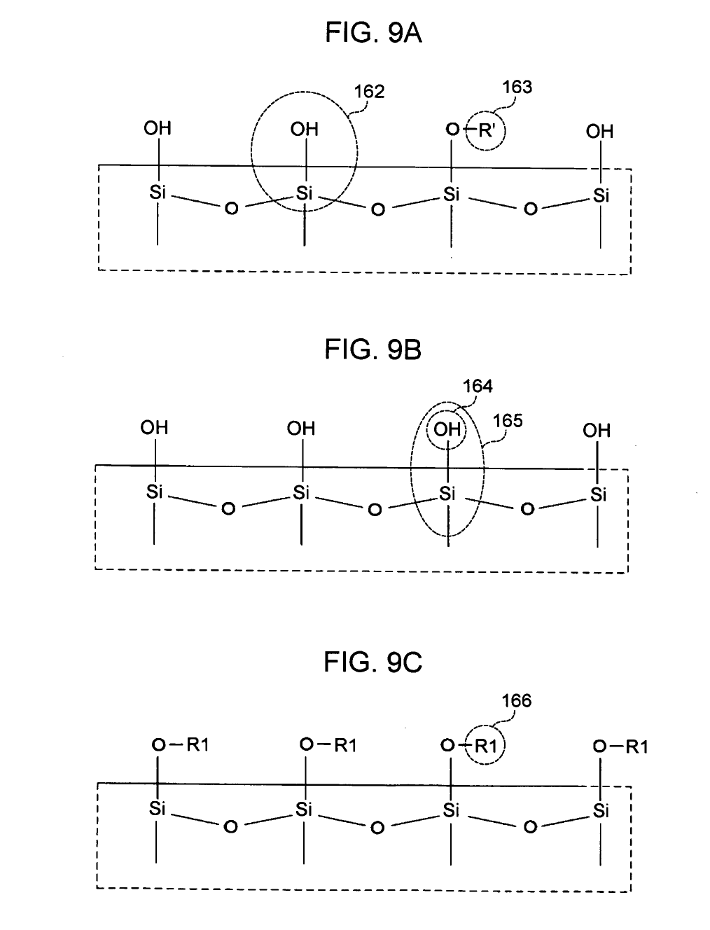

A method for manufacturing the above-described electro-optic device will be described with reference to FIGS. 7 to 9. FIG. 7 is a flow chart illustrating steps of the process for manufacturing the electro-optic device according to the embodiment of the invention. FIG. 8 is a flow chart illustrating in detail steps for modifying a surface. FIGS. 9A, 9B, and 9C are schematic views showing in turn the chemical structures of the surface of an alignment film in the respective steps for modifying the surface.

First, as shown in FIG. 7, the pixel electrodes 9a are formed by, for example, sputtering ITO in the uppermost layer of the laminated structure 90 (refer to FIG. 3) on the TFT array substrate 10, the laminated structure 90 including the data lines 6a, the scanning lines 11a, the TFTs 30, etc. formed by deposition, e.g., evaporation or sputtering, patterning by etching and photography, and heat treatment (Step S11).

Then, in the alignment film forming step, the alignment film 16 composed of silica (SiO₂) is formed by, for example, oblique evaporation, to a thickness of, for example, about 40 nm on the surface of the TFT array substrate 10 on which the pixel electrodes 9a have been formed, (Step S12). The alignment film 16 may be formed by anisotropic sputtering or a coating method such as ink-jet printing. In this case, a vapor stream of the inorganic material such as silica (SiO₂) generated from an evaporation source comes in contact with the uppermost surface of the laminated structure 90 on the surface of the TFT array substrate 10 to deposit the inorganic material on the laminated structure 90. In addition, the columnar structures 16a of the inorganic material deposited on the surface of the substrate are arrayed at a predetermined angle with respect to the surface of the substrate to deposit the inorganic material on the surface of the substrate.

Next, the organic compound, e.g., isopropanol, is fixed by reaction to the surface of the alignment film 16 on the side facing the liquid crystal layer 50, for modifying the surface (Step S13).

Step 13 will be described in detail below with reference to FIGS. 8 and 9A, 9B, and 9C.

As shown in FIG. 8, in the impurity removing step, first, impurities such as moisture in air and organic substances, which are adsorbed on or bonded by chemical reaction to the surface of the alignment film 16 formed by the alignment film forming step on the surface facing the liquid crystal layer 50, are removed by O₂ plasma (Step S131). Specifically, as shown in FIG. 9A, the silanol groups 162 due to reaction with external moisture, hydrocarbon groups 163 with unknown compositions due to reaction to impurities such as organic compounds and the like are formed on the surface of the alignment film 16 formed by the alignment film forming step on the surface facing the liquid crystal layer 50. Therefore, the alignment film 16 is exposed to an O₂ plasma atmosphere for, for example, about 5 minutes, to remove the silanol groups 162 and the hydrocarbon groups 163 from the surface of the alignment film 16 together with the moisture and impurities adsorbed on the surface. In this case, the reactivity of the surface of the alignment film 16 is increased by exposure to the O₂ plasma atmosphere. In other words, the surface of the alignment film 16 is put into a reaction active state.

Next, as shown in FIG. 9B, in the hydroxyl group generating step, the alignment film 16 is immersed in pure water at, for example, room temperature to generate hydroxyl groups 164 or silanol groups 165 (Step S132). In this step, since the silanol groups 162 and the hydrocarbon groups 163 are removed, together with the moisture and impurities adsorbed on the surface, by the impurity removing step, the hydroxyl groups 164 or the silanol groups 165 are substantially or preferably, completely, uniformly formed. Furthermore, the surface of the alignment film 16 is in a reaction active state and thus may be easily and securely reacted to pure water, thereby producing the hydroxyl groups 164 or the silanol groups 165.

Then, the alignment film 16 is heated in a nitrogen atmosphere, for example, for about 5 minutes at about 150° C. to remove the water adsorbed on the surface (Step S133).

Next, isopropanol is physically adsorbed on the surface of the alignment film 16 by supplying isopropanol gas in a nitrogen atmosphere (Step S134). In this step, the alignment film 16 is heated, for example, for about 30 minutes at about 150° C. to 200° C.

Next, the supply of isopropanol gas is stopped, and isopropanol is fixed by reaction to the surface of the alignment film 16 in the reaction fixing step. Namely, as shown in FIG. 9C, isopropyl groups 166 are produced (Step S135). More specifically, the alignment film 16 is heated at about 150° C. for about 60 minutes to cause a dehydration reaction between isopropanol and the hydroxyl groups 164 or the silanol groups 165 on the surface of the alignment film 16. In this case, the surface of the alignment film 16 is substantially or completely free from silanol groups which easily produce a photochemical reaction with the liquid crystal layer 50. Therefore, display defects due to the photochemical reaction between the alignment film 16 and the liquid crystal layer 50 are prevented. In addition, the impurity removing step, the hydroxyl group generating step, and the adsorption step are performed as pre-steps before the reaction fixing step, and thus isopropanol may be substantially or completely uniformly fixed by reaction to the surface of the alignment film 16 on the side facing the liquid crystal layer 50. Therefore, it may be possible to manufacture an electro-optic device having higher light stability.

Isopropanol has substantially no short-wavelength absorption band of about 300 to 400 nm or less, and thus absorption of light used for, for example, a projector, may be prevented. Therefore, it may be possible to more securely suppress the photochemical reaction between the liquid crystal molecules and the silanol groups 162 near the surface of the alignment film 16.

After the reaction fixing step, the alignment film 16 is maintained in a nitrogen atmosphere while being heated at, for example, about 150° C., to release unreacted materials adsorbed on the surface of the alignment film 16. This results in the achievement of uniform surface modification.

In FIG. 7, the laminated structure including the light shielding film 23, the counter electrode 21, and the like formed therein by deposition such as evaporation or sputtering is formed on the counter substrate 20 in parallel with or in tandem with Steps S11 and S12 for the TFT array substrate 10 (Step S21). Then, like in Step S12, in the alignment film forming step, the alignment film 22 is formed (Step S22). Next, like in Step S13, in the surface modifying step, the surface of the alignment film 22 on the side facing the liquid crystal layer 50 is modified (Step S23).

Then, in the bonding step, the TFT array substrate 10 and the counter substrate 20 are bonded together with the sealing material 52 so that the surface of the TFT array substrate 10 on which the alignment film 16 has been formed faces the surface of the counter substrate 20 on which the alignment film 22 has been formed (Step S30).

Then, a liquid crystal is injected between the TFT array substrate 10 and the counter substrate 20 which are bonded together (Step S40).

As described above, the method for manufacturing the electro-optic device according to the embodiment of the invention is capable of manufacturing the above-descried electro-optic device. In particular, the organic compound is fixed by reaction to the surface of each of the alignment films 16 and 22 on the side facing the liquid crystal layer 50, and it may be possible to manufacture an electro-optic device having high light stability.

(Electronic Apparatus)

Next, description will be made of various electronic apparatuses to which a liquid crystal device as an example of the electro-optic device is applied.

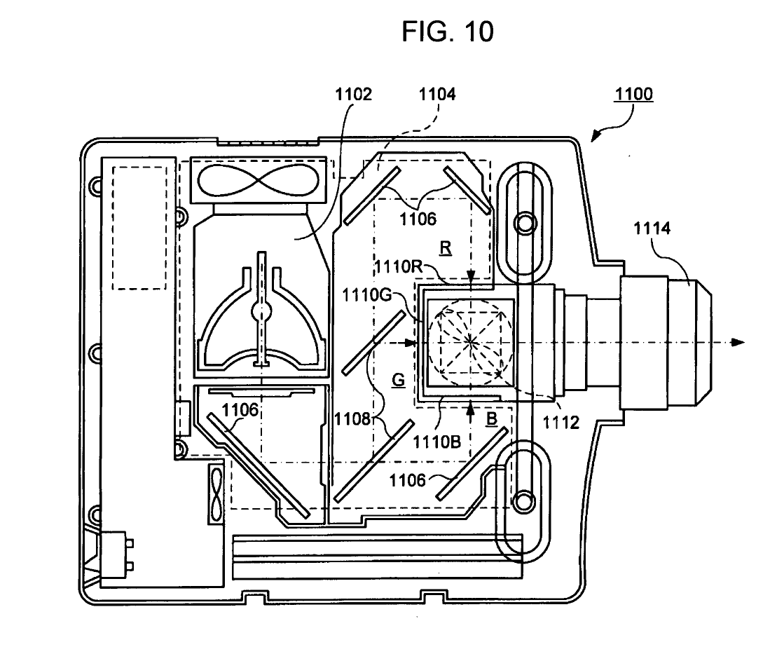

First, a projector using the liquid crystal device as a light valve is described. FIG. 10 is a plan view showing an example of the configuration of a projector. As shown in FIG. 10, a projector 1100 includes a lamp unit 1102 including a white light source such as a halogen lamp or the like. The projection light emitted from the lamp unit 1102 is separated into the RGB primary colors by four mirrors 1106 and two dichroic mirrors 1108 which are provided in a light guide 1104 and incident as light valves corresponding to the respective primary colors on liquid crystal panels 1110R, 1110G, and 1110B, respectively.

The liquid crystal panels 1110R, 1110G, and 1110B each have the same configuration as the above-described liquid crystal device and are driven by RGB primary color signals, respectively, supplied from an image signal processing circuit. The lights modulated by the liquid crystal panels are incident on a dichroic prism 1112 from three directions. In the dichroic prism 1112, R and B lights are refracted at 90 degrees, while G light travels straight. Therefore, combination of images of the respective colors results in the projection of a color image on a screen or the like through a projection lens 1114.

Now, consideration is given to a display image of each of the liquid crystal panels 1110R, 1110G, and 1110B. A display image of the liquid crystal panel 1110G may be mirror-reversed with respect to the display images of the liquid crystal panels 1110R and 1110B.

Since lights corresponding to the primary colors RGB are incident on the liquid crystal panels 1110R, 1110G, and 1110B, respectively, through the dichroic mirrors 1108, a color filter may not be provided.

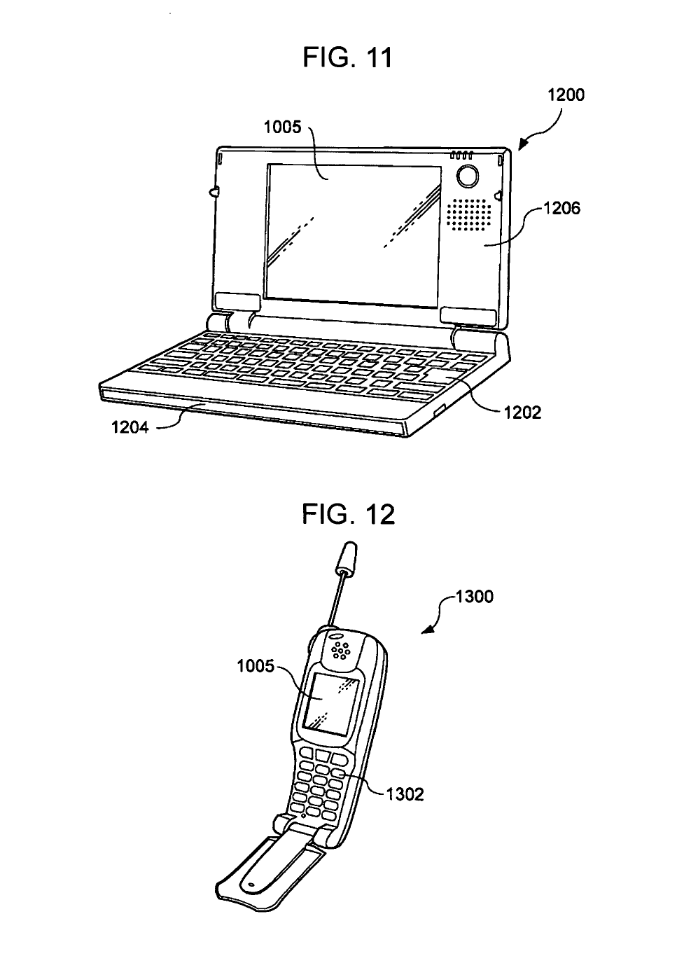

Next, description will be made of an example in which the liquid crystal device is applied to a mobile personal computer. FIG. 11 is a perspective view showing the configuration of the personal computer. In FIG. 11, the computer 1200 includes a body part 1204 provided with a keyboard 1202, and a liquid crystal display unit 1206. The liquid crystal display unit 1206 is formed by adding a back light to the back of the above-described liquid crystal device 1005.

Furthermore, description will be made of an example in which the liquid crystal device is applied to a cellular phone. FIG. 12 is a perspective view showing the configuration of the cellular phone. In FIG. 12, the cellular phone 1300 includes a plurality of operating buttons 1302, and the reflective liquid crystal device 1005. The reflective liquid crystal device 1005 is provided with a front light on the front side according to demand.

Besides the electronic apparatuses described above with reference to FIGS. 10 to 12, examples of the electronic apparatuses include apparatuses such as a liquid crystal television, a view finder-type or monitor direct-view-type video tape recorder, a car navigation device, a pager, an electronic notebook, an electronic calculator, a word processor, a work station, a picture telephone, a POS terminal, and a touch panel. Of course, the liquid crystal device may be applied to these apparatuses.

The present invention is not limited to the above-mentioned embodiment, and appropriate modifications may be made within the scope of the gist or idea of the invention which is understood from the claims and the whole of the specification. The technical field of the invention includes such modifications of an electro-optic device, a method for manufacturing an electro-optic device, and an electronic apparatus including the electro-optic device.

What is claimed is:

1. An electro-optic device comprising:
a pair of first and second substrates;
an electro-optic material sandwiched between the pair of first and second substrates;
an alignment film for controlling the alignment state of the electro-optic material, the alignment film being formed from an inorganic material on a surface of at least one of the first and second substrates on the side facing the electro-optic material; and
an organic compound fixed to the alignment film by reaction.

2. The electro-optic device according to claim 1, wherein the organic compound has a predetermined wavelength absorption band.

3. The electro-optic device according to claim 1, wherein the organic compound is an alcohol.

4. The electro-optic device according to claim 1, wherein the organic compound is a silane compound.

5. The electro-optic device according to claim 1, wherein the organic compound is a fatty acid.

6. An electronic apparatus comprising the electro-optic device according to claim 1.

7. A method for manufacturing an electro-optic device including a pair of first and second substrates, and an electro-optic material sandwiched between the pair of first and second substrates, the method comprising:
forming an alignment film on at least one of the first and second substrates using an inorganic material, for controlling the alignment state of the electro-optic material;
fixing an organic compound to a surface of the alignment film by reaction on the side facing the electro-optic material; and
bonding the first and second substrates together.

8. The method according to claim 7 further comprising, before the reaction fixing:
removing impurities of the surface;
generating hydroxyl groups on the surface after the removal of impurities; and
adsorbing the organic compound on the surface after the hydroxyl groups are generated;
wherein the organic compound has a predetermined wavelength absorption band.

9. The electro-optic device according to claim 1, wherein the organic compound is bonded to a functional group of the alignment film by a chemical reaction.

10. The electro-optic device according to claim 9, wherein the organic compound is bonded to a functional group of the alignment film by a chemical reaction.

11. The electro-optic device according to claim 10, wherein the alignment film includes silanol groups are bonded to the organic compound due to dehydration reaction.
